(19) United States
(12) Patent Application Publication
(10) Pub. No.: US 2017/0099536 A1
(43) Pub. Date: Apr. 6, 2017

(54) ELECTROACOUSTIC TRANSDUCER WITH FLEXIBLE COILWIRE CONNECTION

(71) Applicant: Sound Solutions International Co., Ltd., Beijing (CN)

(72) Inventors: Michael Schoeffmann, Baden (AT); Erich Klein, Himberg (AT)

(21) Appl. No.: 15/286,839

(22) Filed: Oct. 6, 2016

Related U.S. Application Data
(60) Provisional application No. 62/237,967, filed on Oct. 6, 2015.

(51) Int. Cl. H04R 1/06; H04R 1/28; H04R 9/02; H04R 9/06

(52) U.S. Cl. CPC H04R 1/06; H04R 9/06; H04R 1/2803; H04R 9/02

(57) ABSTRACT

A new audio transducer for mobile devices, in particular for a micro speaker, having a coil assembly having a coil, a pair of leads extending from the coil, and a flexible printed circuit having a pair of contact pads to which the leads are directly electrically connected. An advantage of this new speaker is the reduced number of electrical connections between the leads of the coil and the driver of the coil. This helps to reduce the number and size of the parts of the micro speaker and aids in increasing sound quality and durability of the speaker.

### BACKGROUND OF THE INVENTION

a. Field of the Invention

The invention relates to an audio transducer, such as a speaker to transduce an electrical audio signal into acoustic sound or a receiver to transduce an acoustic sound into an electrical audio signal. This invention furthermore relates to a micro speaker optimized for high acoustic output and located within a small volume of a mobile device, such as a mobile phone, a tablet, a gaming device, a notebook or similar device.

b. Background Art

Prior art micro speakers for use in mobile devices include a coil fixed to the membrane of the speaker. The coil includes two leads to feed an electrical signal into the coil. The coil is arranged within a magnetic field formed of a population of magnets. The electrical signal fed into the coil causes the coil and connected membrane to vibrate which generates an acoustic sound in relation to the electrical signal. Prior art micro speakers include a frame to align and fix the parts of the speaker. The frame includes contact pads which provide the electrical interface between the coil and the audio electronics of the mobile device.

### SUMMARY OF THE INVENTION

It is an object of the invention to have an audio transducer for mobile devices without the disadvantages of known transducers. A new audio transducer for mobile devices, in particular for a micro speaker, comprises a coil assembly having a coil, a pair of leads extending from the coil, and a flexible printed circuit having a pair of contact pads to which the leads are directly electrically connected. An advantage of this new speaker is the reduced number of electrical connections between the leads of the coil and the driver of the coil. This helps to reduce the number and size of the parts of the micro speaker and aids in increasing sound quality and durability of the speaker. Further details and advantages of such an audio transducer will become apparent in the following description and the accompanying drawings.

Briefly therefore, one aspect of the invention is directed to an audio transducer, comprising a substantially rectangular pot plate having a perimeter, a substantially rectangular collar, a membrane, a magnet system, and coil assembly. The substantially rectangular collar includes a first portion substantially parallel to the pot plate, a substantially rectangular hole extending through the first portion of the collar. A second portion of the collar extends substantially perpendicular downward from the first portion, and a support tab extends substantially perpendicular outward from the second portion. The membrane includes a perimeter affixed to the first portion of the collar. The magnet system includes a perimeter magnet assembly, a center magnet assembly, and an air gap formed between the perimeter magnet assembly and the center magnet assembly. The perimeter assembly comprises a population of outer magnets arranged proximate the perimeter of the pot plate and a ring plate affixed to the population of outer magnets. The center magnet assembly comprises a center magnet affixed to the pot plate and substantially surrounded by the population of outer magnets of the perimeter magnet system, and a top plate affixed to the center magnet. The coil assembly includes a coil located in the air gap, wherein the coil has a top side affixed to the membrane. A pair of electrical leads extend from the coil and are directly electrically connected to a pair of contact pads on a flexible printed circuit. The support tab of the collar is affixed to the flexible printed circuit.

While embodiments of the audio transducer are shown and described as having a rectangular shape, it will be understood that in other embodiments, the audio transducer may have a variety of shapes, including, but not limited to, circular and ovular. Accordingly, the invention is not limited to audio transducers having a rectangular shape.

### BRIEF DESCRIPTION OF THE DRAWINGS

These and other aspects, features, details, utilities, and advantages of the invention will become more fully apparent from the following detailed description, appended claims, and accompanying drawings, wherein the drawings illustrate features in accordance with exemplary embodiments of the invention, and wherein:

FIG. 1 shows an exploded top perspective view of the relevant parts of a prior art rectangular micro speaker;

FIG. 2A shows a bottom perspective view of the relevant parts of a prior art rectangular micro speaker;

FIG. 2B shows a bottom perspective view of the relevant parts of a prior art rectangular micro speaker;

FIG. 3 shows an exploded top perspective view of a rectangular micro speaker according to a first embodiment of the invention;

FIG. 4 shows a top perspective view of a coil assembly of a rectangular micro speaker according to the first embodiment of the invention;

FIG. 5 shows a top perspective view of a rectangular micro speaker according to the first embodiment of the invention;

FIG. 6 is a flowchart describing a method of manufacturing the rectangular micro speaker according to the first embodiment of the invention;

FIG. 7 is a top perspective view of a rectangular micro speaker within an enclosure according to the first embodiment of the invention;

FIG. 8A is a top perspective view of a collar of a rectangular micro speaker according to a second embodiment of the invention;

FIG. 8B is a bottom perspective view of a rectangular micro speaker according to a second embodiment of the invention;

FIG. 9A is a bottom perspective view of a collar of a rectangular micro speaker according to the third embodiment of the invention;

FIG. 9B is a top perspective view of a collar of a rectangular micro speaker according to the third embodiment of the invention.

Like reference numbers refer to like or equivalent parts in the several views.

### DETAILED DESCRIPTION OF EMBODIMENTS

Various embodiments are described herein to various apparatuses. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It must be noted that, as used in this specification and the appended claims, the singular forms “a,” “an” and “the” include plural referents unless the content clearly dictates otherwise.

The terms “first,” “second,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “rear,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

All numbers expressing measurements and so forth used in the specification and claims are to be understood as being modified in all instances by the term “about.”

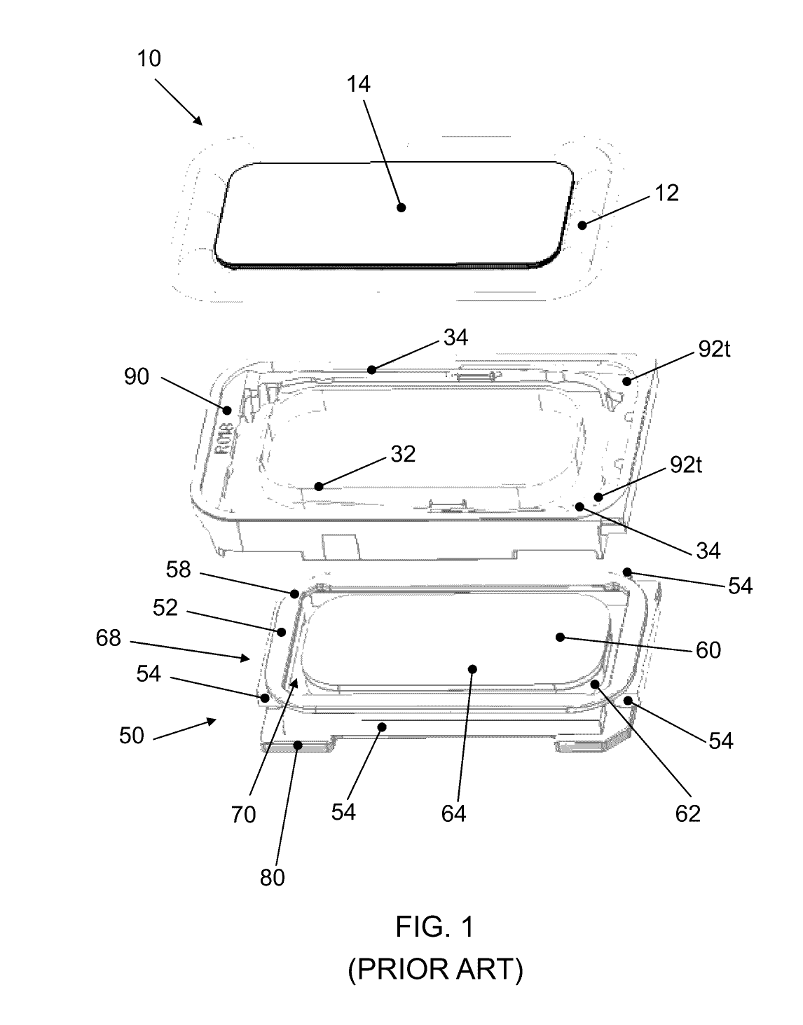

FIG. 1 shows an exploded perspective view of the relevant parts of a prior art rectangular micro speaker 10. Speaker 10 comprises a membrane 12 that is typically built out of one or more layers of material, such as, for example, Ethere Ketone (PEEK), Acrylate and/or Thermoplastic Elastomeric (TEP), Polyetherimide (PEI), and/or other materials known in the art. Membrane 12 may also include a membrane plate 14 to stiffen membrane 12. Speaker 10 furthermore comprises a coil 32 with leads 34. An electrical signal to drive coil 32 is fed into coil 32 through leads 34. Coil 32 of assembled speaker 10 is fixed to membrane 12 with an adhesive, such as, for example, glue, tape, or other adhesives known in the art.

Speaker 10 includes a magnet system 50 comprising a perimeter magnet assembly 52 and a center magnet assembly 60. Perimeter magnet assembly 52 includes four magnets 54 arranged on the rectangular sides of the rectangular speaker 10 and ring plate 58 fixed to magnets 54. Center magnet assembly 60 includes magnet 62 arranged in the center of speaker 10 and top plate 64 fixed to magnet 62. Perimeter magnet assembly 52, center magnet assembly 60, and pot plate 80 affixed to perimeter and center magnet assemblies 52, 60 opposite ring and top plates 58, 64 form magnetic field guide 68. Magnetic field guide 68 guides and focuses the magnetic field of magnets 54 and 62 in an air gap 70 between perimeter magnet assembly 52 and center magnet assembly 60, into which coil 32 is arranged in the assembled speaker 10.

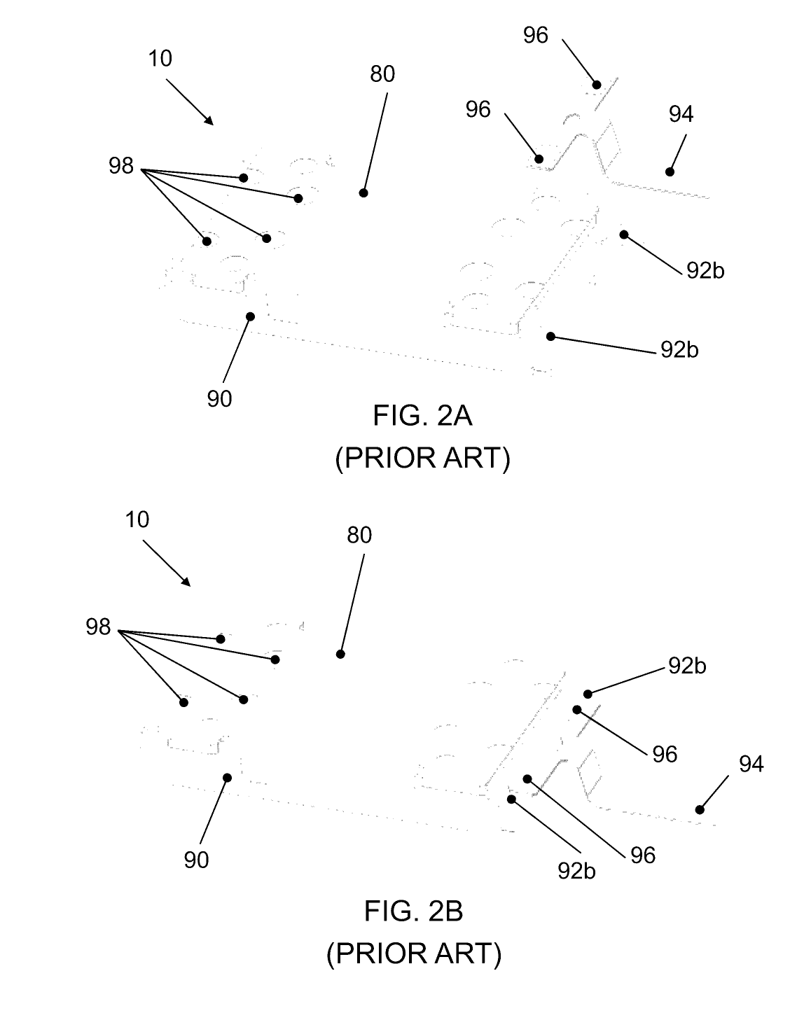

Prior art micro speaker 10 further includes frame 90 to assemble and align membrane 12 with magnet system 50. Coil 32 fits into air gap 70 and is able to translate up and down within air gap 70 according to the electrical signal fed into coil 32 through leads 34. Frame 90 typically is made from a molded plastic which enables frame 90 to have a complex surface with openings which permit airflow and fixation of other parts of speaker 10. The ends of leads 34 of coil 32 are soldered to contact pads 92t, that are fixed in to top side of frame 90 during an assembly process. As shown in FIG. 2A, the bottom side of frame 90 includes contact pads 92b which are electrically connected with contact pads 92t on the top side of frame 90. As shown in FIG. 2B, a further electrical connection is made with flexible printed circuit 94 which includes contact pads 96. Contact pads 96 of flexible printed circuit 94 are soldered to contact pads 92b during an assembly process. The electrical signal to drive coil 32 is fed through flexible printed circuit 94, contact pads 96, contact pads 92b, contact pads 92t, and into leads 34. Furthermore as shown in FIGS. 2A and 2B, pot plate 80 includes bottom vents 98 which permit airflow between a back volume (not shown) and the back volume side of the membrane 12. Bottom vents 98 permit an undistorted vibration of membrane 12 according to the electrical signal fed into coil 32.

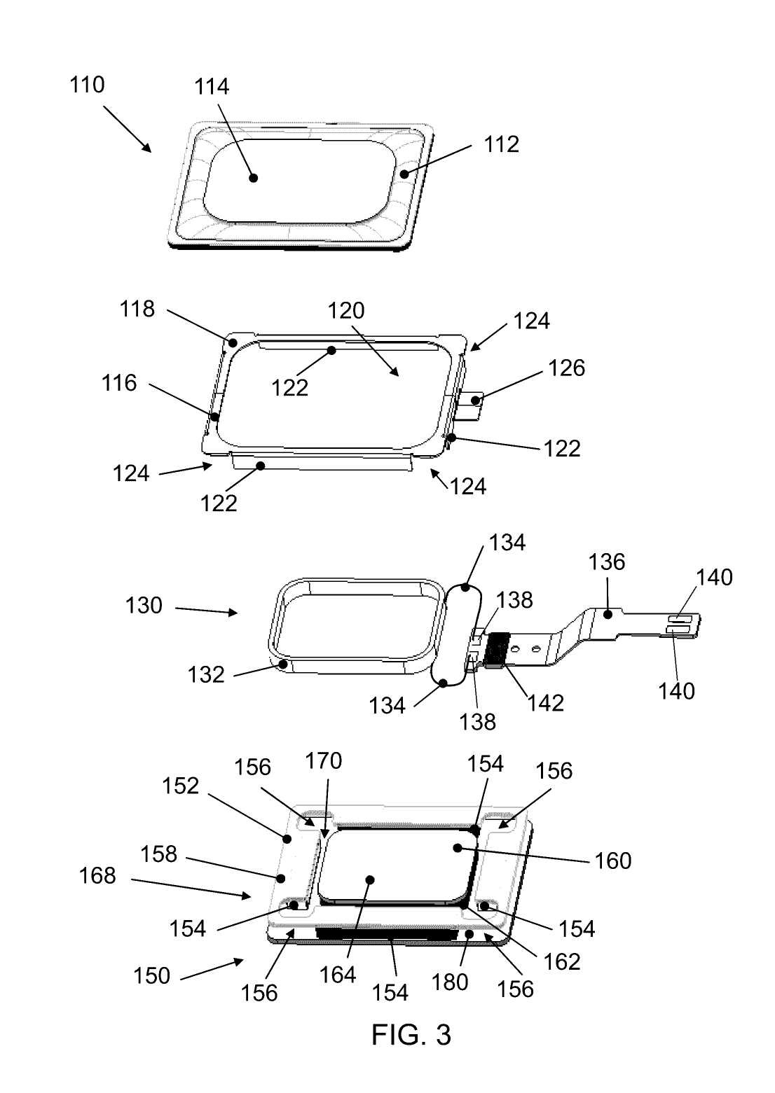

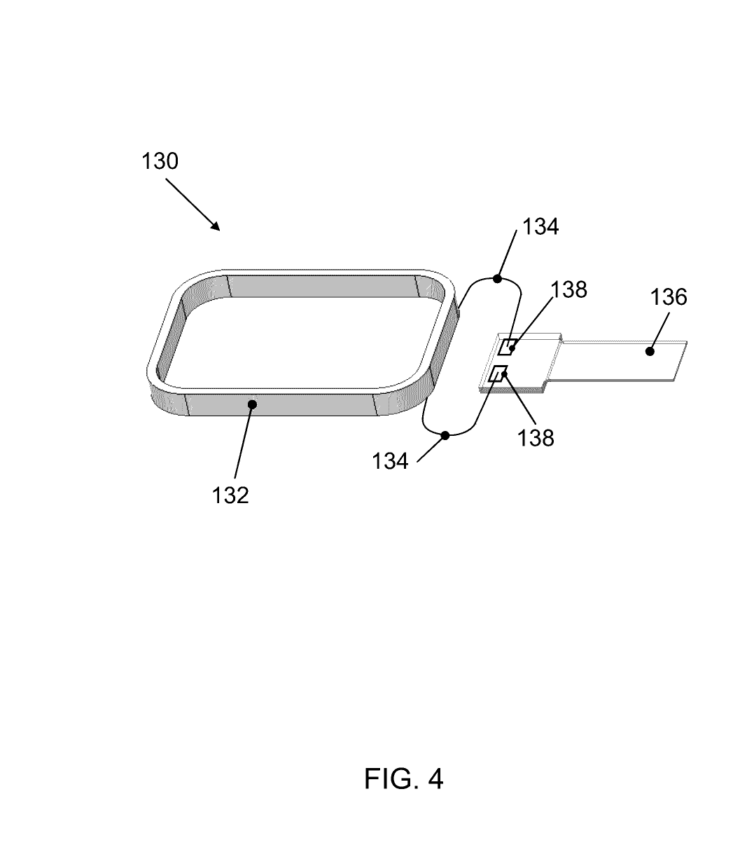

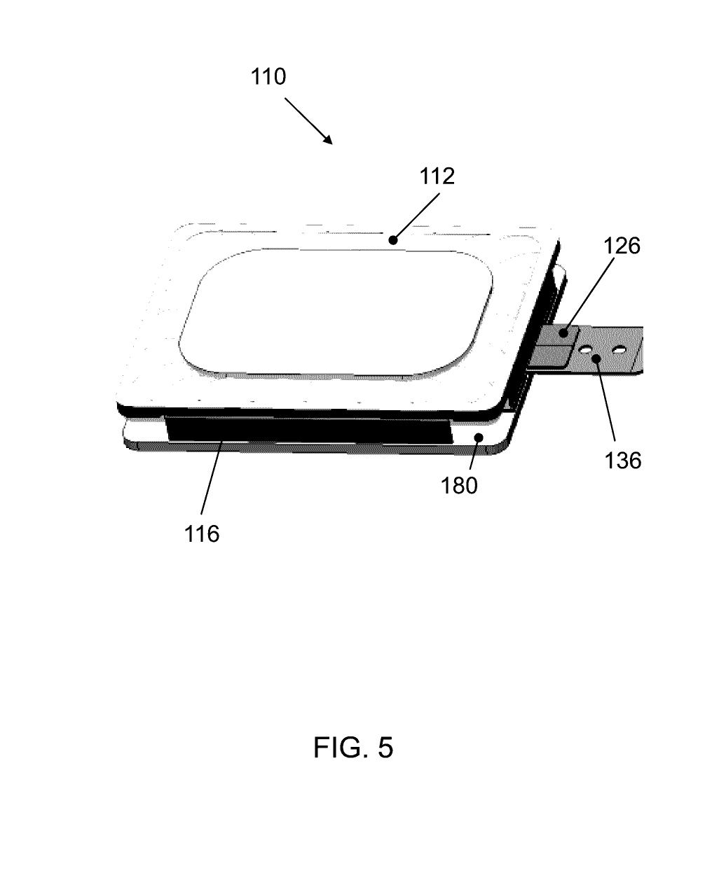

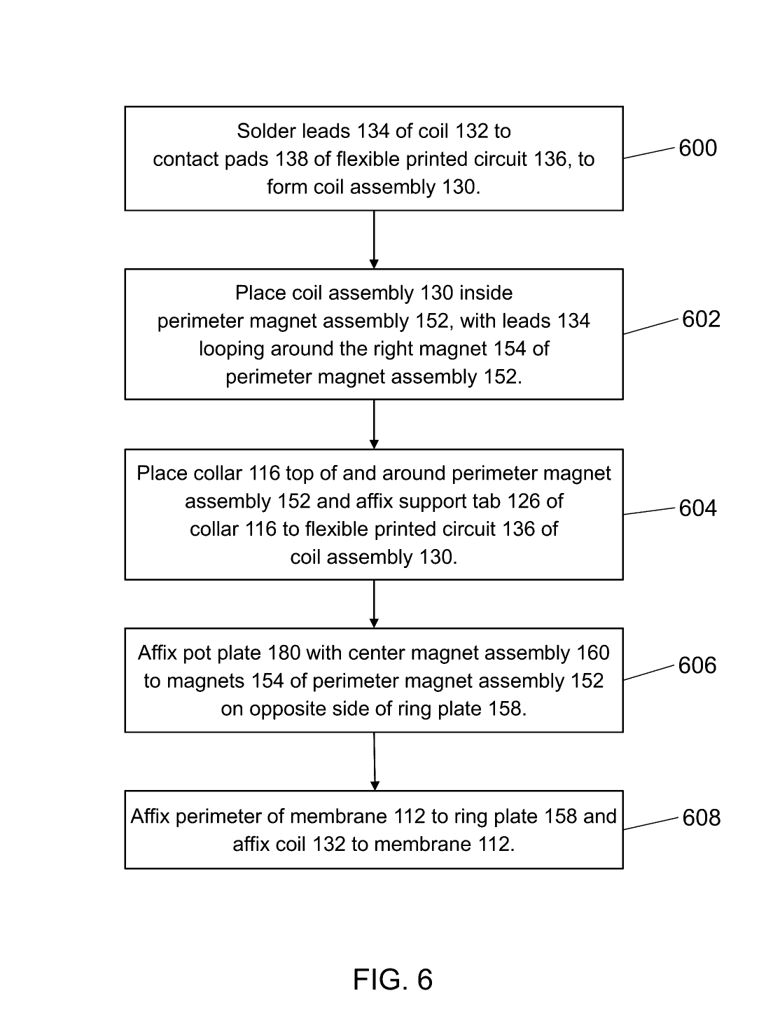

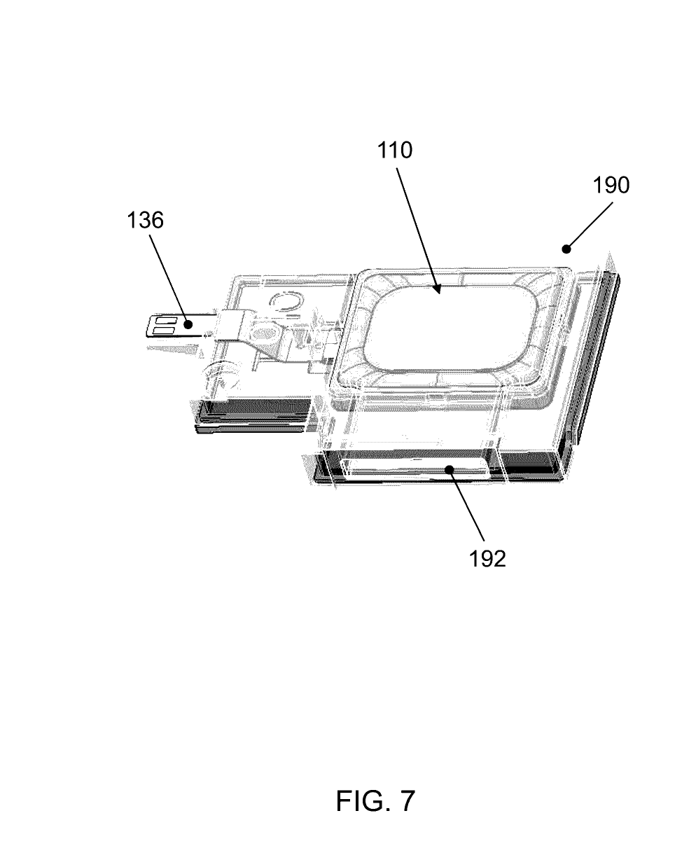

The relevant parts of a first embodiment of the invention is shown in FIGS. 3, 4, 5, 6, and 7. FIG. 3 shows an exploded perspective view of the relevant parts of a rectangular speaker 110. FIG. 4 shows a perspective view of an assembly of a coil 132 and flexible printed circuit 136. FIG. 5 shows a top perspective view the relevant parts of the assembled speaker 110. FIG. 6 is a flowchart describing a method of manufacturing speaker 110. FIG. 7 is a top perspective view of the assembled speaker 110 within an enclosure 190.

Speaker 110 comprises a membrane 112, a collar 116, a coil assembly 130, a magnet system 150, and a pot plate 180. Membrane 112 may be built out of one or more layers of material, such as, for example, Ethere Ketone (PEEK), Acrylate and/or Thermoplastic Elastomeric (TEP), Polyetherimide (PEI), and/or other materials known in the art. Membrane 112 may also include a membrane plate 114 to stiffen membrane 112.

Speaker 110 includes a magnet system 150 comprising a perimeter magnet assembly 152 and a center magnet assembly 160. Perimeter magnet assembly 152 includes four magnets 154 arranged on the rectangular sides of the rectangular speaker 110 and ring plate 158 fixed to magnets 154. Center magnet assembly 160 includes magnet 162 arranged in the center of speaker 110 and top plate 164 fixed to magnet 162. Perimeter magnet assembly 152, center magnet assembly 160, and pot plate 180 affixed to perimeter and center magnet assemblies 152, 160 opposite ring and top plates 158, 164 form magnetic field guide 168. Magnetic field guide 168 guides and focuses the magnetic field of magnets 154 and 162 in an air gap 170 between perimeter magnet assembly 152 and center magnet assembly 160, into which coil 132 is arranged in the assembled speaker 110.

Speaker 110 includes coil assembly 130 having coil 132, leads 134, and flexible printed circuit 136. An electrical signal to drive coil 132 is fed into coil 132 through flexible printed circuit 136 and leads 134. Coil 132 of assembled speaker 110 is fixed to membrane 112 with an adhesive, such as, for example, glue, tape, or other adhesives known in the art. Unlike prior art micro speakers, leads 134 of coil 132 are directly connected to flexible printed circuit 136. Flexible printed circuit 136 includes a pair of contact pads 138 on a first terminal end of flexible printed circuit 136 which are in electrical communication with contact pads 140 on a second terminal end of the printed circuit 136 opposite the first. The electrical communication between contact pads 140 and 138 may be accomplished using traces and/or vias as is known in the art. Leads 134 are electrically connected by a solder connection to contact pads 138 to permit an electrical signal to flow from a source (not shown) into contact pads 140, through traces and/or vias in flexible printed circuit 136, through contact pads 138, through leads 134 and into coil 132. It will be understood by those in the art, that in various embodiments, the electrical connection between leads 134 and flexible printed circuit 136 may be accomplished in a variety of ways known in the art, for example, by inserting leads 134 into an electrical connector affixed to flexible printed circuit 136.

Unlike prior art micro speaker 10 shown in FIGS. 1, 2A, and 2B, micro speaker 110 does not require contact pads 92t and contact pads 92b to be included in frame 90. By eliminating the additional components required to transmit the electrical signal from the source to coil 132, the size may be reduced, the component and manufacturing costs may be reduced, and durability and sound quality may be increased for speaker 110 as compared to prior art speaker 10. For example, by connecting leads 134 directly to contact pads 138 of flexible printed circuit 136, the number of electrical connections are reduced to one for each lead 134.

As shown in FIGS. 3 and 4, leads 134 of coil 132 extend from the side of coil 132 proximate flexible printed circuit 136 and each lead 134 forms a short loop. This allows leads 134 to be shorter in length than leads 34 of prior art micro speaker 10. However, in other embodiments, for example, leads 134 of coil 132 may extend from the side of coil 132 distal flexible printed circuit 136 and loop inward to be electrically connected to contact pads 138 of flexible printed circuit 136. As shown, leads 134 extend from the bottom of coil 132 and may be substantially horizontal and substantially in-plane with flexible printed circuit 136 when coil is in the rest position. In various embodiments, speaker 110 may also include one or more of the support members for supporting coil 132 and/or leads 134 as described in U.S. Provisional Application 62/147,801, filed on Apr. 15, 2015, entitled “Speaker with Supported Coil Wire,” the entirety of which is incorporated by reference herein.

Due to the direct electrical connection between leads 134 and flexible printed circuit 136, the frame 90 of prior art micro speaker 10 may be replaced with collar 116 as shown in FIG. 3. Collar 116 has a first portion 118 that is substantially horizontal and substantially parallel with pot plate 180. A substantially rectangular opening 120 is provided in first portion 118 through which coil 132 may translate during operation of speaker 110. First portion 118 serves as a rim to which the perimeter of membrane 112 is affixed typically, for example, by glue or adhesive. Extending downward and substantially perpendicular from the sides of first portion 118 of collar 116 is a second portion, shown as side tabs 122. Preferably, collar 116 includes four (4) side tabs; however, it will be understood that, in various embodiments, for example, collar 116 may include from about two (2) tabs to about four (4) tabs (e.g., two (2) tabs, three (3) tabs, four (4) tabs). In other embodiments, collar 116 may include less than two (2) tabs. In yet other embodiments, collar 116 may include more than four (4) tabs.

With continued reference to FIG. 3, collar 116 further includes openings 124 proximate the corners of collar 116 between tabs 122. Preferably, collar 116 includes four (4) openings; however, it will be understood that, in various embodiments, for example, collar 116 may include from about two (2) openings to about four (4) openings (e.g., two (2) openings, three (3) openings, four (4) openings). In other embodiments, collar 116 may include less than two (2) openings. In yet other embodiments, collar 116 may include more than four (4) openings. Openings 124 serve as side vents which permit airflow between a back volume (not shown) and the back volume side of membrane 112. As illustrated in FIGS. 3 and 5, openings 124 are substantially aligned with the gaps 156 between magnets 154 of magnet system 150 and thus speaker 110 includes a substantially clear air pathway between the back volume and the back volume side of membrane 112. Therefore, openings 124 permit an undistorted vibration of membrane 112 in response to the electrical signal fed into coil 132. With the inclusion of openings 124 on collar 116, back vents are not required in pot plate 180. By not requiring back vents on pot plate 180, the geometry and/or features of pot plate 180 can be simplified as compared to pot plate 80 of prior art speakers, thus reducing component cost. It will be understood however, that in various embodiments, in addition to or alternative to openings on collar 116, back vents may be provided on pot plate 180.

Collar 116 further includes a stabilizing tab 126 extending substantially horizontally from right tab 122. As shown in FIG. 5, stabilizing tab 126 interfaces with flexible printed circuit 136, serves to stabilize flexible printed circuit 136, provides protection between the electrical connection between leads 134 and contact pads 138, and maintains the positions of collar 116 and coil assembly 130 in speaker 110. Stabilizing tab 126 is affixed to flexible printed circuit 136 using an adhesive 142 (see FIG. 3), such as, for example, glue, tape, or other adhesives known in the art.

The assembled speaker 110 is shown in FIG. 5. Now with reference to FIG. 6, an embodiment of assembling speaker 110 is illustrated. At step 600, leads 134 of coil 132 are soldered to contact pads 138 of flexible printed circuit 136 to form coil assembly 130. At step 602, coil assembly 130 is placed inside perimeter magnet assembly 152, with leads 134 looping around the right magnet 154 of perimeter magnet assembly 152. At step 604, collar 116 is placed on top of and around perimeter magnet assembly 152 and support tab 126 of collar 116 is affixed to flexible printed circuit 136 of coil assembly 130. At step 606, pot plate 180 with center magnet assembly 160 is affixed to magnets 154 of perimeter magnet assembly 152 on opposite side of ring plate 158. At step 608, the perimeter of membrane 112 is affixed to ring plate 158 and coil 132 is affixed to membrane 112. This method results in assembled speaker 110 as shown in FIG. 5. While various steps are described herein in one order, it will be understood that other embodiments of the method can be carried out in any order and/or without all of the described steps without departing from the scope of the invention.

Assembled speaker 110, may be installed in an enclosure 190 as shown in FIG. 7. Enclosure 190 is illustrated with a sound path terminating in a side firing port 192; however, it will be understood that in various embodiments, the enclosure of speaker 110 may include a sound path terminating in a top or bottom firing port. Enclosure 190 further includes a passageway through which flexible printed circuit 136 exits so that it may be connected to circuitry source (not shown) for driving speaker 110.

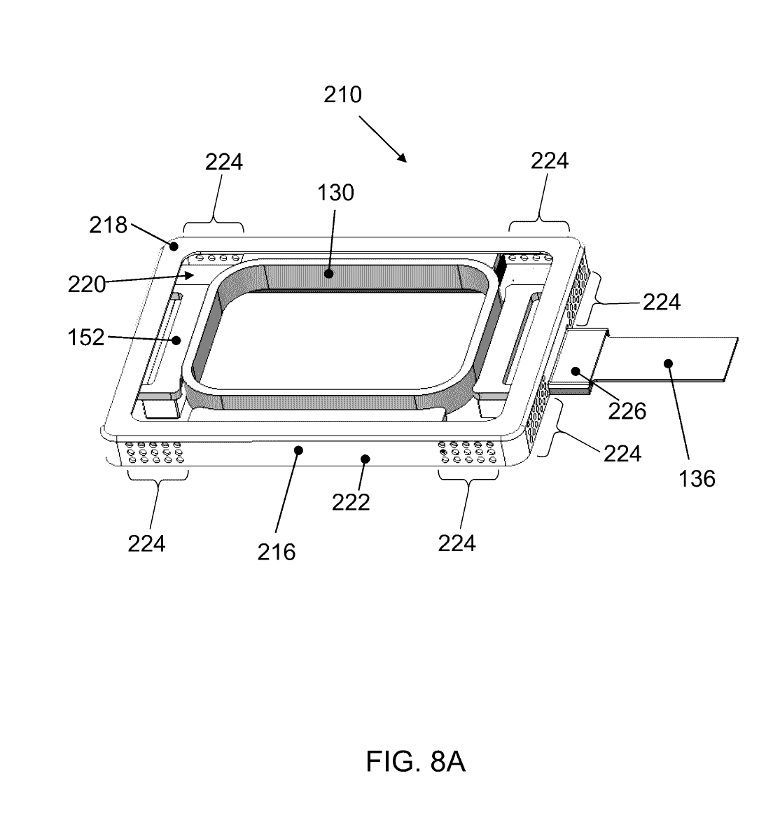

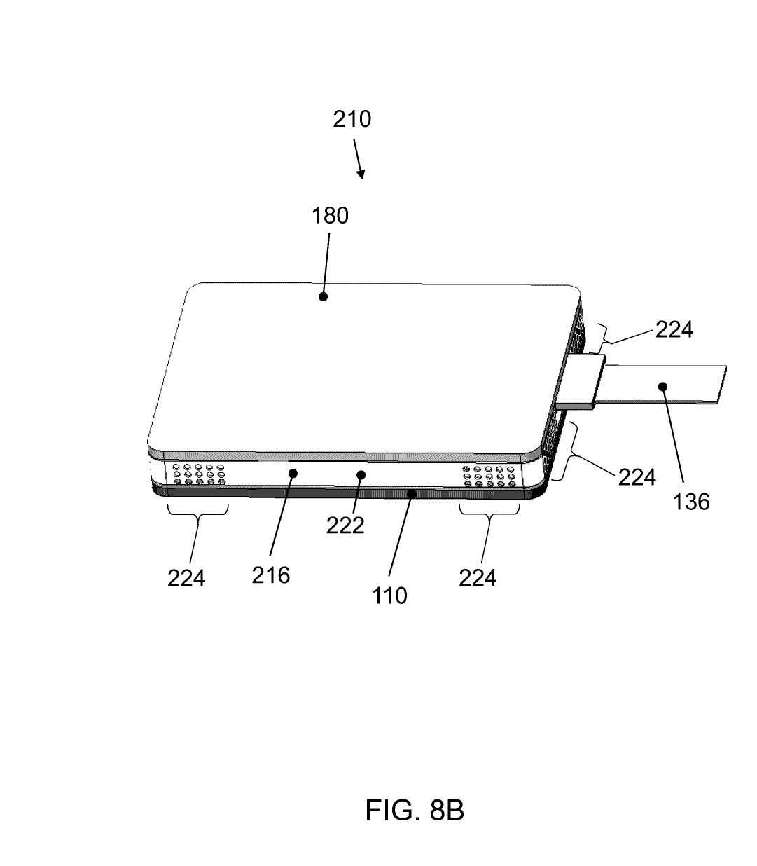

Another embodiment of speaker 210 of the invention is illustrated in FIGS. 8A, 8B and are described below. Some features of one or more of speakers 110 and 210 are common to one another and, accordingly, descriptions of such features in one embodiment should be understood to apply to other embodiments. Furthermore, particular characteristics and aspects of one embodiment may be used in combination with, or instead of, particular characteristics and aspects of another embodiment.

With reference to FIG. 8A, a portion of speaker 210 is shown. Speaker 210 comprises a membrane 112, a collar 216, a coil assembly 130, a magnet system 150, and a pot plate 180. Speaker 210 is substantially the same as speaker 110 except for the design of collar 216. collar 216 has a first portion 218 that is substantially horizontal and substantially parallel with pot plate 180 (see FIG. 8B). A substantially rectangular opening 220 is provided in first portion 218 through which coil 132 may translate during operation of speaker 210. First portion 218 serves as a rim to which the perimeter of membrane 112 is affixed typically, for example, by glue or adhesive. Extending downward and substantially perpendicular from the sides of first portion 218 of collar 216 is a second portion, shown as sidewall 222. Sidewall 222 extends around the perimeter of collar 216.

With continued reference to FIG. 8A, sidewall 222 includes a population of openings 224 extending through sidewall 222 proximate the corners of collar 216. Openings 224 are shown as substantially circular holes arranged in rows and columns. In various embodiments, for example, openings 224 may be laser cut into sidewall 222. Openings 224 serve as side vents which permit airflow between a back volume (not shown) and the back volume side of membrane 112. As illustrated in FIG. 8A, openings 224 are substantially aligned with the gaps between magnets 154 of magnet system 150 and thus speaker 210 includes a substantially clear air pathway between the back volume and the back volume side of membrane 112. Therefore, openings 224 permit an undistorted vibration of membrane 112 in response to the electrical signal fed into coil 132. With the inclusion of openings 224 on collar 216, back vents are not required in pot plate 180 as shown in FIG. 8B. By not requiring back vents on pot plate 180, the geometry and/or features of pot plate 180 can be simplified as compared to pot plate 80 of prior art speakers, thus reducing component cost. It will be understood however, that in various embodiments, in addition to or alternative to openings on collar 216, back vents may be provided on pot plate 180.

It will be understood that the number and/or the size of openings 224 may be altered to provide the appropriate side venting to a back volume (not shown) to achieve the desired acoustic performance for speaker 210. Furthermore, as described in U.S. Provisional Application filed on Oct. 6, 2015, having Attorney Docket Number 112256-0090, entitled “Electroacoustic Transducer,” the entirety of which is incorporated by reference, openings 224 may have a maximum dimension smaller than an adsorber material filled into an enclosure. The adsorber material may be, for example, the zeolite material described in U.S. Published Patent Application 2013/0170687, published on Jul. 4, 2013, entitled “Loudspeaker System with Improved Sound.”

Collar 216 further includes a stabilizing tab 226 extending substantially horizontally from sidewall 222. As shown in FIG. 8A, stabilizing tab 226 interfaces with flexible printed circuit 136, serves to stabilize flexible printed circuit 136, provides protection between the electrical connection between leads 134 and contact pads 138, and maintains the positions of collar 216 and coil assembly 130 in speaker 210. Stabilizing tab 226 is affixed to flexible printed circuit 136 using an adhesive 142 (see FIG. 3), such as, for example, glue, tape, or other adhesives known in the art.

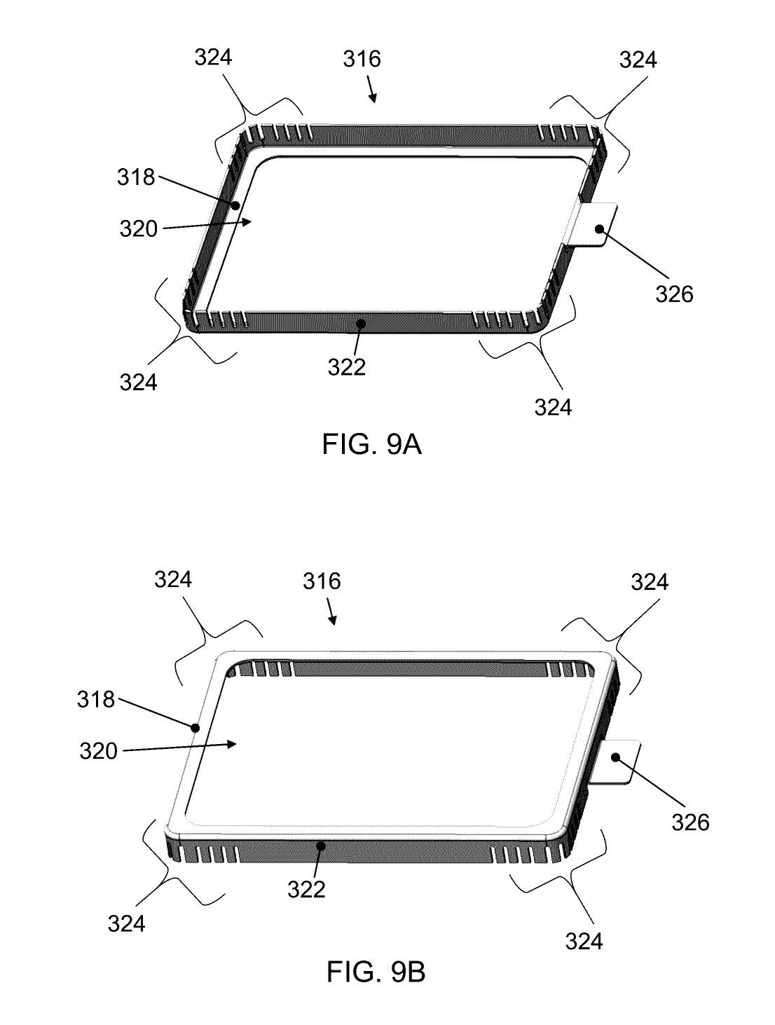

Another embodiment of collar 316 of the invention is illustrated in FIGS. 9A, 9B and are described below. Some features of one or more of collars 216 and 316 are common to one another and, accordingly, descriptions of such features in one embodiment should be understood to apply to other embodiments. Furthermore, particular characteristics and aspects of one embodiment may be used in combination with, or instead of, particular characteristics and aspects of another embodiment.

Collar 316 has a first portion 318 that is substantially horizontal and substantially parallel with a pot plate 180. A substantially rectangular opening 320 is provided in first portion 318 through which a coil 132 may translate during operation of a speaker 110. First portion 318 serves as a rim to which the outer perimeter of a membrane 112 is affixed typically, for example, by glue or adhesive. Extending downward and substantially perpendicular from the sides of first portion 318 of collar 316 is a second portion, shown as sidewall 322. Sidewall 322 extends around the perimeter of collar 316.

Sidewall 322 includes a population of openings 324 extending through sidewall 322 proximate the corners of collar 316. Openings 324 are shown as slots arranged in columns. The slot openings 324 are shown as extending from the terminal end of sidewall 322 up toward first portion 318 of collar 316. In various embodiments, for example, openings 324 may be laser cut into sidewall 322. Openings 324 serve as side vents which permit airflow between a back volume (not shown) and the back volume side of a membrane 112. Openings 324 may be substantially aligned with the gaps between magnets 154 of magnet system 150 and thus a speaker may include a substantially clear air pathway between the back volume and the back volume side of membrane 112. Therefore, openings 324 permit an undistorted vibration of membrane 112 in response to the electrical signal fed into coil 132. With the inclusion of openings 324 on collar 316, back vents are not required in pot plate 180 as shown in FIG. 8B. By not requiring back vents on pot plate 180, the geometry and/or features of pot plate 180 can be simplified as compared to pot plate 80 of prior art speakers, thus reducing component cost. It will be understood however, that in various embodiments, in addition to or alternative to openings on collar 316, back vents may be provided on pot plate 180.

Collar 316 further includes a stabilizing tab 326 extending substantially horizontally from sidewall 322. Stabilizing tab 326 functions the same as stabilizer tab 226 shown in FIG. 8A. Stabilizing tab 326 interfaces with flexible printed circuit 136, serves to stabilize flexible printed circuit 136, provides protection between the electrical connection between leads 134 and contact pads 138, and maintains the positions of collar 316 and coil assembly 130 in the speaker. Stabilizing tab 326 is affixed to flexible printed circuit 136 using an adhesive 142 (see FIG. 3), such as, for example, glue, tape, or other adhesives known in the art.

While embodiments of the audio transducer are shown and described as having a rectangular shape, it will be understood that in other embodiments, the audio transducer may have a variety of shapes, including, but not limited to, circular and ovular. Accordingly, the invention is not limited to audio transducers having a rectangular shape.

In closing, it should be noted that the invention is not limited to the above mentioned embodiments and exemplary working examples. Further developments, modifications and combinations are also within the scope of the patent claims and are placed in the possession of the person skilled in the art from the above disclosure. Accordingly, the techniques and structures described and illustrated herein should be understood to be illustrative and exemplary, and not limiting upon the scope of the present invention. The scope of the present invention is defined by the appended claims, including known equivalents and unforeseeable equivalents at the time of filing of this application.

1. (canceled)

2. A coil assembly for an audio transducer, the coil assembly comprising:
a coil;
a pair of leads extending from the coil; and
a flexible printed circuit to which the pair of leads from the coil are electrically connected.

3. The coil assembly of claim 1, wherein the flexible printed circuit further comprises a pair of contact pads, and wherein a first lead of the pair of leads is electrically connected to a first contact pad of the pair of contact pads and a second lead of the pair of leads is electrically connected to a second contact pad of the pair of contact pads.

4. The coil assembly of claim 2, wherein the first lead is electrically connected to the first contact pad via solder and the second lead is electrically connected to the second contact pad via solder.

5. The coil assembly of claim 1, wherein the flexible printed circuit further comprises a first pair of contact pads proximate a first terminal end of the flexible printed circuit and a second pair of contact pads proximate a second terminal end of the flexible printed circuit opposite the first terminal end, wherein corresponding contact pads of the first and second pair of contact pads are in electrical communication.

6. The coil assembly of claim 4, wherein a first lead of the pair of leads is electrically connected to a first contact pad of the first pair of contact pads and a second lead of the pair of leads is electrically connected to a second contact pad of the first pair of contact pads.

7. The coil assembly of claim 5, wherein the electrical connection between the pair of leads and the first pair of contact pads and the electrical communication between the first pair of contact pads and the second pair of contact pads permits an electrical signal to flow between the second pair of contact pads to the coil.

8. The coil assembly of claim 1, wherein the flexible printed circuit includes an electrical connector affixed thereto, into which the pair of leads are inserted.

9. The coil assembly of claim 1, wherein each lead of the pair of leads extends from the coil proximate the flexible printed circuit and forms a partial loop.

10. An audio transducer, comprising:
a pot plate having a perimeter;
a magnet system comprising:
a perimeter magnet assembly comprising a perimeter magnet arranged proximate the perimeter of the pot plate;
a center magnet assembly comprising a center magnet affixed to the pot plate and surrounded by the perimeter magnet assembly; and
an air gap formed between the perimeter magnet assembly and the center magnet assembly;
a membrane assembly comprising a membrane; and
a coil assembly comprising:
a coil located in the air gap, wherein the coil has a top side affixed to the membrane assembly;
a pair of leads extending from the coil; and
a flexible printed circuit to which the pair of leads from the coil are electrically connected.

11. The audio transducer of claim 9, wherein the perimeter magnet is located between the coil and the flexible printed circuit.

12. The audio transducer of claim 9, wherein at least one lead of the pair of leads extends from proximate a first side of the perimeter magnet, around the perimeter magnet and to proximate a second side of the perimeter magnet opposite the first side of the perimeter magnet.

13. The audio transducer of claim 9, further comprising a collar assembly sandwiched between the membrane assembly and the pot plate, the collar comprising:
a first portion parallel to the pot plate; and
a second portion extending downward from the first portion.

14. The audio transducer of claim 12, wherein the collar further comprises a stabilizing tab extending from the second portion.

15. The audio transducer of claim 13, wherein the stabilizing tab extends outward away from the center magnet assembly.

16. The audio transducer of claim 13, wherein the stabilizing tab interfaces with the flexible printed circuit to maintain the position of the coil assembly in the audio transducer.

17. The audio transducer of claim 13, wherein the stabilizing tab is affixed to the flexible printed circuit.

18. The audio transducer of claim 12, wherein the collar further comprises one or more openings extending through the second portion.

19. The audio transducer of claim 9, wherein the flexible printed circuit further comprises a pair of contact pads, and wherein a first lead of the pair of leads is electrically connected to a first contact pad of the pair of contact pads and a second lead of the pair of leads is electrically connected to a second contact pad of the pair of contact pads.

20. The audio transducer of claim 9, wherein the membrane assembly is affixed to the first portion of the collar.

21. An audio transducer, comprising:
a rectangular pot plate having a perimeter;
a rectangular collar comprising:
a first portion parallel to the pot plate;
a second portion extending downward from the first portion: and
a support tab extending perpendicular from the second portion;
a membrane assembly comprising a membrane having a perimeter affixed to the first portion of the collar;
a magnet system comprising:
a perimeter magnet assembly comprising:
a population of perimeter magnets arranged proximate the perimeter of the pot plate; and
a ring plate affixed to the population of outer magnets;
a center magnet assembly comprising a center magnet affixed to the pot plate and surrounded by the perimeter magnet assembly; and
an air gap formed between the perimeter magnet assembly and the center magnet assembly; and
a coil assembly comprising:
a coil located in the air gap, wherein the coil has a top side affixed to the membrane assembly;
a pair of leads extending from the coil; and
a flexible printed circuit to which the pair of leads from the coil are electrically connected, wherein at least one of the population of perimeter magnets is located between the coil and the flexible printed circuit, and wherein the pair of leads are located between the ring plate and the pot plate.
